(19) United States
(12) Patent Application Publication
(10) Pub. No.: US 2014/0127379 A1
(43) Pub. Date: May 8, 2014

(54) SHELF-STABLE TEXTURED SANDWICH SPREADS

(71) Applicants: Ritu Mishra, Pleasanton, CA (US); Daniela N. Fritter, Pleasanton, CA (US); Joanna L. Oldaker, Pleasanton, CA (US); Rachel Watson-Clark, Pleasanton, CA (US)

(72) Inventors: Ritu Mishra, Pleasanton, CA (US); Daniela N. Fritter, Pleasanton, CA (US); Joanna L. Oldaker, Pleasanton, CA (US); Rachel Watson-Clark, Pleasanton, CA (US)

(73) Assignee: The Clorox Company, Oakland, CA (US)

(21) Appl. No.: 13/669,643

(22) Filed: Nov. 6, 2012

(51) Int. Cl. A23L 1/22

(52) U.S. Cl. CPC A23L 1/22058
USPC 426/582

(57) ABSTRACT

Textured sandwich spread or dip compositions comprising a dairy component comprising cream cheese, an oil-water emulsion comprising oil and water, and a legume-based component. The combination of cream cheese and the legume-based component provide a significantly more hearty texture to the composition than that provided by existing sandwich spreads, such as mayonnaise or mustard. The composition is advantageously phase stable so as to provide excellent shelf-stability so that proteins and other solid components of the composition do not retrograde or precipitate, even when hot filled into a container during preparation and packaging.

### FIELD OF THE INVENTION

The present invention relates to a shelf stable emulsified food composition having a texture and consistency suitable for use as a sandwich spread, dip or the like and can be used to replace mayonnaise, mustard or other traditional sandwich spread condiments used by consumers.

### DESCRIPTION OF RELATED ART

Many consumers enjoy sandwiches. Typically, a layer of a relatively thick, viscous spreadable composition, such as mayonnaise, mustard, or both is applied to the inside surfaces of the bread of such sandwiches to provide moistness and flavor to the overall combination of fillings and bread included in the sandwich.

### BRIEF SUMMARY OF THE INVENTION

According to one embodiment, the present invention relates to shelf stable sandwich spreads and dips that comprise a combination of a dairy component comprising cream cheese, an oil-water emulsion comprising oil and water for providing moisture and creaminess, and a legume-based component (e.g., a bean-based component provided in the form of bean paste or bean flakes). The cream cheese and legume-based components together provide a unique hearty texture to the sandwich spread or dip composition. The legume-based component can be made from of any type of edible legume (e.g., bean or lentil). Examples of various suitable beans include, but are not limited to kidney beans, navy beans, garbanzo beans, pinto beans, fava beans, soybeans (e.g., edamame), or combinations thereof.

One embodiment is directed to a shelf-stable textured sandwich spread or dip composition including a dairy component comprising cream cheese, an oil-water emulsion comprising oil and water, and a legume-based component. The dairy component, the oil-water emulsion, and the legume-based component exhibit phase stability such that proteins and other solid components of the composition do not retrograde or precipitate. The composition may exhibit an elastic modulus of less than 100,000 Pa and a phase angle of at least 9 degrees.

Another embodiment is directed to a shelf-stable textured sandwich spread or dip composition including a dairy component comprising cream cheese, the cream cheese comprising from about 3% to about 30% by weight of the composition, an oil-water emulsion comprising oil and water, and a legume-based component. The dairy component, the oil-water emulsion, and the legume-based component exhibit phase stability such that proteins and other solid components of the composition do not retrograde or precipitate, even when hot filled into a container.

Yet another embodiment is directed to a shelf-stable textured sandwich spread or dip composition including a dairy component comprising cream cheese, the cream cheese comprising from about 3% to about 30% by weight of the composition, an oil-water emulsion comprising oil and water, and a bean-based component selected from the group consisting of kidney beans, navy beans, garbanzo beans, pinto beans, fava beans, soybeans, and combinations thereof. The dairy component, the oil-water emulsion, and the legume-based component exhibit phase stability such that proteins and other solid components of the composition do not retrograde or precipitate, even when hot filled into a container.

Mayonnaise typically comprises an emulsion of oil, water, and egg yolk. Lecithin within the yolk serves as an emulsifier to aid in emulsifying the hydrophilic and hydrophobic components. While such compositions are traditionally employed as sandwich spreads, they provide a smooth texture and flavor that some might regard as relatively bland. The compositions advantageously provide characteristics not currently available in sandwich spread compositions. For example, the composition may be characterized by a texture and flavor that is significantly more “hearty” than that provided by mayonnaise. Such texture and flavor characteristics are provided at least in part by the inclusion of the cream cheese and legume-based components of the composition. The oil-water emulsion provides the composition with moistness and creaminess characteristics.

The inclusion of cream cheese and bean-based or other legume-based components within the composition advantageously can be achieved while maintaining phase stability. For example, dairy components typically undergo syneresis (separation of liquid from gel or solid components of the dairy composition), protein precipitation, or other phase separation phenomenon upon acidification of the dairy component. Similarly, legume-based components (e.g., beans) typically retrograde as the solids separate from water present in the bean during storage (e.g., as will be apparent to anyone who has opened a can of refried beans). Advantageously, despite these challenges, the composition can be provided in a phase stable condition so that such phase separation phenomenon do not occur within the composition as it sits on a store shell, even where the composition is hot-filled into a container during preparation of the composition. The fact that phase stability can be achieved is particularly advantageous as such hot-tilling has typically been regarded as exacerbating the problems of phase separation described above.

The features and advantages of composition of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The invention will be described and explained with additional specificity and detail through the use of the accompanying drawings in which:

FIG. 1 is a plot of strain versus elastic modulus for two exemplary inventive compositions as compared to cream cheese;

FIG. 2 is a plot of strain versus elastic modulus for two exemplary inventive compositions as compared to mayonnaise;

FIG. 3 is a plot of strain versus phase angle for two exemplary inventive compositions as compared to mayonnaise;

FIG. 4A is a plot of strain versus elastic modulus for various exemplary inventive compositions as compared to mayonnaise and cream cheese;

FIG. 4B is a plot of strain versus phase angle for the various exemplary inventive compositions and comparative mayonnaise and cream cheese compositions of FIG. 4A;

FIG. 5A is a plot of elastic modulus versus phase angle for various exemplary inventive compositions as compared to mayonnaise, cream cheese, and other similar food compositions; and

FIG. 5B is a close up plot of a portion of the plot of FIG. 5A, plotting elastic modulus versus phase angle for various exemplary inventive compositions as compared to mayonnaise, cream cheese, and other similar food compositions.

### DETAILED DESCRIPTION OF THE PREFERRED EMBODIMENTS

### I. Definitions

Before describing the present invention in detail, it is to be understood that this invention is not limited to particularly exemplified compositions, systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

References herein to “one embodiment”, “one aspect” or “one version” of the invention include one or more such embodiments, aspects or versions, unless the context clearly dictates otherwise.

As used in this specification and the appended claims, the singular forms “a”, “an”, and “the” include plural referents unless the context clearly dictates otherwise.

Unless defined otherwise, all technical and scientific terms used herein have the same meaning as commonly understood by one of ordinary skill in the art to which the invention pertains. Although a number of compositions, methods and materials similar or equivalent to those described herein can be used in the practice of the present invention, the preferred compositions, materials and methods are described herein.

In the application, effective amounts are generally those amounts listed as the ranges or levels of ingredients in the description, which follow hereto. Unless otherwise stated, amounts listed in percentage (“%'s”) are in weight percent (based on 100% active) of the active composition alone.

The precise definition of a “flavorant” is difficult since its literal definition includes anything that contributes flavor to food. A legal definition by the U.S. Code of Federal Regulations, a natural flavorant is: “the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or any other edible portions of a plant, meat, seafood, poultry, eggs, dairy products, or fermentation products thereof, whose primary function in food is flavoring rather than nutritional.”

The term flavorant includes such natural flavorants, and includes, but is not limited to, essential oils, oleoresins, oil-based natural flavors and mixtures and combinations thereof. An “essential oil” is any concentrated, hydrophobic liquid containing volatile aroma compounds from plants. Essential oils are natural products commonly used in foods and beverages for their fragrance and taste properties. “Oleoresins” are a naturally occurring mixture of an oil and a resin extracted from various plants.

All numbers expressing quantities of ingredients, constituents, reaction conditions, and so forth used in the specification and claims are to be understood as being modified in all instances by the term “about”. Notwithstanding that the numerical ranges and parameters setting forth the broad scope of the subject matter presented herein are approximations, the numerical values set forth in the specific examples are reported as precisely as possible. Any numerical value, however, inherently contains certain errors necessarily resulting from the standard deviation found in their respective testing measurements.

The term “food safe” refers to compositions, which are comprised entirely of materials that are considered food grade, and/or Generally Recognized As Safe (GRAS) and/or Everything Added to Food in the U.S. (EAFUS). In the United States, ingredients pre-approved for food use are listed in the United States Code of Federal Regulations (“C.F.R.”), Title 21. Food safe materials may also include ingredients that are well established as safe, have adequate toxicological and safety pedigree, can be added to existing lists, or approved via a self-affirmation process.

### II. Introduction

According to one embodiment, the shelf-stable sandwich spread or dip composition comprises a dairy component comprising cream cheese, an oil-water emulsion comprising oil and water, and a legume-based component. The oil-water emulsion provides moisture and creaminess to the composition, while the combination of cream cheese and the legume-based component together provide a texture that is significantly more hearty than that provided by mayonnaise emulsion compositions. In addition, the composition is shelf-stable so that the composition maintains its substantially homogenous bulk characteristics, even after storage for weeks or months. As such, the various composition components do not retrograde, separate, or precipitate out over the shelf-life of the product (e.g., often up to 1 year).

### III. Cream Cheese Dairy Component

The dairy component comprising cream cheese is included within the composition to aid in providing the desired hearty texture to the composition. Cream cheese generally refers to a mild soft unripened cheese made from whole sweet milk enriched with cream. The U.S. Department of Agriculture defines cream cheese as containing at least 33% by weight fat (milk fat plus cream) with a moisture content of not more than 55%, and a pH range of 4.4 to 4.9. Because of the high cream content (i.e., cream is added to the milk), cream cheese exhibits a higher fat content than many other cheeses. Cream cheese may typically exhibit a protein content of about 6% by weight and a carbohydrate content of about 4% by weight. Cream cheese is not typically matured as some other soft cheeses (e.g., Brie) are.

Cream cheese manufacture typically requires careful control of process conditions. Protein molecules in milk typically have a negative surface charge, which keeps milk in a liquid form. The protein component in the mixture acts as a surfactant or emulsifier to aid in forming an emulsion. The protein molecules may surround the fat particles, forming micelles so as to keep them in emulsion. Lactic acid bacteria are typically added to pasteurized and homogenized milk. During fermentation (e.g., at about 23° C.) the pH level of the milk decreases. Amino acid components at the surface of the proteins begin losing charge, becoming more neutral. This results in the fat micelles losing their hydrophilic characteristics, so that they become increasingly hydrophobic, which causes the liquid to begin to coagulate. If the bacteria are allowed to act on the milk too long, the pH continues to drop, the micelles may attain a positive charge and the mixture may return to a liquid, but inverted emulsion form. Thus, the bacteria are inactivated before phase inversion can occur, maintaining the coagulated characteristics of the milk and cream composition. This may typically be achieved by heating the composition (e.g., from about 52° C. to about 63° C.) at or close to the moment where the composition is in an isoelectric condition, where about half the ionizable surface amino acids of the proteins are positively charged and half are negative.

The cream cheese component employed in the sandwich spread or dip composition may be provided in a dry or wet form. For example, after preparation, cream cheese may be dried (e.g., freeze dried) and powdered. Alternatively, the cream cheese may simply be provided in the form of a soft cheese (e.g., having characteristics similar to those exhibited by PHILADELPHIA or other brand cream cheese sold in grocery stores). In an embodiment, a combination of wet and dry cream cheese products may be employed (e.g., cream cheese powder and cream cheese sauce). Exemplary suppliers of suitable cream cheese component(s) include Kerry Group, located in Ireland, and DairiConcepts, located in Springfield, Mo.

In one embodiment, additional acids are added to the composition, which acids may have a tendency to cause syneresis of the dairy component(s). Advantageously, the components may be combined and processed in a manner that prevents or minimizes any such tendency of the dairy component(s) to undergo syneresis, protein precipitation, or other phase separation phenomenon. Exemplary methods of preparation of the shelf-stable sandwich spread or dip composition are described in the Examples section below.

In one embodiment, the cream cheese comprises about 3% to about 30%, about 5% to about 30%, or about 10% to about 20% by weight of the sandwich spread or dip composition,

### IV. Legume-Based Component

The legume-based component, in combination with the cream cheese, is included within the composition to aid in providing the desired hearty texture to the composition. While beans are preferred for use as the legume-based component, other legumes, such as lentils or peas may be employed. Legumes refer to a dry dehiscent one-celled fruit developed from a simple superior ovary and usually dehiscing into two valves with the seeds attached to the ventral suture. Examples of legumes include beans, peas, and lentils. Various varieties of beans may be employed as the legume-based component, examples of which include, but are not limited to, kidney beans, navy beans, garbanzo beans (also known as chickpeas), pinto beans, fava beans (also known as broad beans), soybeans (e.g., edamame).

The legume-based component may be provided in a form other than whole beans or other legumes. For example, the beans or other legumes may have been processed to be provided in the form of bean flakes, bean granules, bean powder, or combinations thereof. Similar forms may be employed where other legumes (e.g., peas or lentils) are used. In one embodiment, the legume-based component does not comprise dry, unmodified soybeans because of the potential “beany” off-notes associated with such a component.

In one embodiment, the legume-based component comprises about 0.5% to about 5%, or about 1% to about 4% by weight of the sandwich spread or dip composition. The ratio of the legume-based component to the cream cheese, which together provide the desired hearty texture, may range from about 0.25:10 to about 10:10, from about 0.5:10 to about 5:10, or from about 1:10 to about 3:10. Typically, the cream cheese may be present in a weight fraction that is greater than that of the legume-based component.

### V. Oil-Water Emulsion

The majority of the sandwich spread or dip composition may comprise the oil-water emulsion. The majority of the composition itself may comprise water (i.e., more than 50% by weight of the composition may be water). The oil-water emulsion component of the sandwich spread or dip composition provides moisture and creaminess to the composition, similar to the moistness provided by mayonnaise. As described above, the composition includes cream cheese and a legume-based component to provide a more hearty texture than the simple moistness and creaminess provided by mayonnaise.

The oil of the oil-water emulsion may comprise any edible oil. In an embodiment, the oil may comprise a vegetable oil in liquid form at room temperature, shortening, or combinations thereof. In one embodiment, soy oil is employed. Shortening typically refers to any fat that is solid at room temperature. In one embodiment, the oil may comprise a mixture of a liquid oil and a solid shortening.

In one embodiment, the oil component of the emulsion comprises about 5% to about 35%, about 10% to about 30%, or about 15% to about 20% by weight of the sandwich spread or dip composition. Where both a liquid oil (e.g., soy oil) and shortening are included in the oil component, the ratio of the liquid oil to the shortening, may range from about 0.5:10 to about 25:10, from about 1:10 to about 20:10, or from about 2.5:10 to about 10:10.

In some embodiments, water may comprise the majority of the composition, and is typically present in a weight fraction greater than that of the oil component. For example, the water may comprise from about 30% to about 70%, from about 35% to about 65%, or from about 40% to about 60% (not inclusive of water already present in other composition components) of the sandwich spread or dip composition.

### VI. Optional Components

The sandwich spread or dip composition may typically include various other functional components such as natural and artificial flavorants, thickeners, surfactants, emulsifiers, buffers, fragrances, dyes and/or colorants, vitamins and minerals, solubilizing materials, stabilizers, preservatives, and combinations thereof.

a. Flavorants

As described above in the definitions section, any conceivable edible material may be included so as to provide flavor and/or fragrance to the composition. Such flavorants may typically be, or be derived from a spice, fruit or fruit juice, vegetable or vegetable juice, edible yeast herb, bark, bud, root, leaf or any other edible portions of a plant, meat, seafood, poultry, eggs, or dairy products. Salt may also be present as a flavorant.

Examples of typical specific flavorants may include salt, dried onion, dried garlic, black pepper, parsley flakes, sugar, buttermilk, paprika, other spices, and monosodium glutamate (MSG) as a flavor enhancer.

b. Thickeners

Thickeners, when used, include, but are not limited to, acacia, agar, xanthan gum, cornstarch, calcium carbonate, gelatin, gum tragacanth, starches, pectins, carrageenan, clays, beeswax, gellan gum, guar gum, alginates, cellulose (and derivatives) Pectin (and derivatives) and any other food safe thickeners.

c. Surfactants

One or more surfactants may be included within the composition. Any food safe surfactant may be employed. Surfactants may be nonionic, anionic, cationic, amphiphilic, or zwitterionic. Various classes of suitable surfactants may include polysorbates, polyglycerol esters, glycosides, sorbitan esters, ethoxylated sorbitan esters, sorbitan tristreate, monoglycerides, sucrose esters, ethoxylated castor oils, and combinations thereof.

Other optional surfactants may include those surfactants which act as wetting agents or shirring lubricants. Non-limiting examples of such surfactants include water dispersible or at least partially water-soluble surfactants such as alkylene oxide adducts of either fatty acids or partial fatty acid esters, for example, ethoxylated fatty acid partial esters of such polyols as anhydrosorbitols, glycerol, polyglycerol, pentaerythritol, and glucosides, as well as ethoxylated monodiglycerides, sorbitan trioleate, lecithin, and aliphatic polyoxyethylene ethers such as polyoxyeethylene (23) lauryl ether.

d. Buffers

Optionally, buffering and pH adjusting agents may be included in the composition. Suitable fixxod grade buffers include, but are not limited to, organic acids, mineral acids, alkali metal and alkaline earth salts of silicate, metasilicate, polysilicate, borate, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2-methylpropanol. Additional buffering agents for compositions of this invention include nitrogen-containing materials. Some examples are amino acids such as lysine or lower alcohol amines like mono-, di-, and tri-ethanolamine. Other nitrogen-containing buffering agents are tri(hydroxymethyl)amino methane (TRIS), 2-amino-2-ethyl-1,3-propanediol, 2-amino-2-methyl-propanol, 2-amino-2-methyl-1,3-propanol, disodium glutamate. N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine). Other suitable buffers include potassium citrate, ammonium carbamate, citric acid (e.g., lemon juice), acetic acid (vinegar), and phosphoric acid. Mixtures of any of the above are also acceptable. Useful inorganic buffers/alkalinity sources include ammonia, the alkali metal carbonates and alkali metal phosphates, e.g., sodium carbonate, sodium polyphosphate. For additional buffers see McCutcheon's Emulsifiers and Detergents, North American Edition, 1997. McCutcheon Division, MC Publishing Company Kirk and WO 95/07971, both of which are incorporated herein by reference.

When employed, the buffer may comprise at least about 0.001% and typically about 0.01-10% of the composition. Preferably, the pH adjusting agent or buffer content is about 0.0-5% and more preferably from about 0.05%-2%.

e. Additional Adjuvants

Other optional adjuncts may include, but are not limited to, dyes and/or colorants, vitamins and minerals, solubilizing materials, stabilizers, foam controlling agents, hydrotropes, and/or mineral oils, enzymes, cloud point modifiers, preservatives, polymers and any combinations thereof.

The solubilizing materials, when used, include, but are not limited to, hydrotropes (e.g. water soluble salts of low molecular weight organic acids such as the sodium and/or potassium salts of xylene sulfonic acid). The acids, when used, include, but are not limited to, organic hydroxy acids, acetic acid, adipic acid, ascorbic acid, benzoic acid, lactic acid, phosphoric acid, oleic acid, malic acid, potassium acid tartrate, citric acids, keto acid, and the like.

Foam controlling agents, when used, include, but are not limited to, acacia, silicones and other suitable defoamers. Enzymes, when used, include, but are not limited to, lipases and proteases, and/or hydrotropes and/or toluene sultfonates. Preservatives, when used, include, but are not limited to, acetic acid, adipic acid, ascorbic acid, butylated hydroxyanisole, butylated hydroxytoluene, EDTA, citric acid, calcium propinatesmethyl, ethyl and propyl parabens, short chain organic acids (e.g. acetic, lactic and/or glycolic acids), and/or short chain alcohols (e.g. ethanol and/or IPA).

### VII. Rheology Characteristics

The compositions according to the present invention may typically be relatively thick and viscous. In steady shear viscometry, a material is sheared continuously until steady flow and a constant value of viscosity is reached. The viscosity is determined by the interaction between molecules or structures at a particular shear rate, which can include electrostatic, steric, or dispersion forces, as well as hydrogen bonding and excluded volume effects, among others.

Many materials have structural interactions at rest that are lost in the act of shearing. These include moderately concentrated emulsions or dispersions, and aggregated or flocculated systems that form a container-spanning three-dimensional network, among others. To access this structural information, the material can be subjected to small oscillating deformations and the viscoelastic material response measured.

Dynamic oscillatory rheology is used to measure microstructural interactions in thickened or semi-solid materials (See Sundaram Gunasekaran et al., Dynamic Oscillatory Shear Testing of Foods—Selected Applications. Trends in Food Science & Technology, Vol. 11, 115-127 (2000). A small oscillating stress is applied to the sample, and the resulting strain is measured. In some instruments, strain is applied and stress is measured. The input and output waves are out of phase by a phase angle δ that ranges from 0 degrees for a perfectly elastic response (all energy is stored), to 90 degrees for a perfectly viscous response (all energy is dissipated). The complex modulus G* is the ratio of the maximum stress amplitude to the maximum strain amplitude. The complex modulus can be broken down into an elastic modulus G′ and viscous modulus G″ where G′=G* cos δ and G″=G* sin δ.

Examples of the inventive compositions and comparative benchmark spreads were measured on a Stresstech Rheometer with parallel plate geometry and 1 mm gap (or cone and plate geometry for non-particulate samples), at 10° C. Strain sweep experiments were run at a frequency of 1 Hz, where G′, G″ and other quantities are obtained as a function of strain.

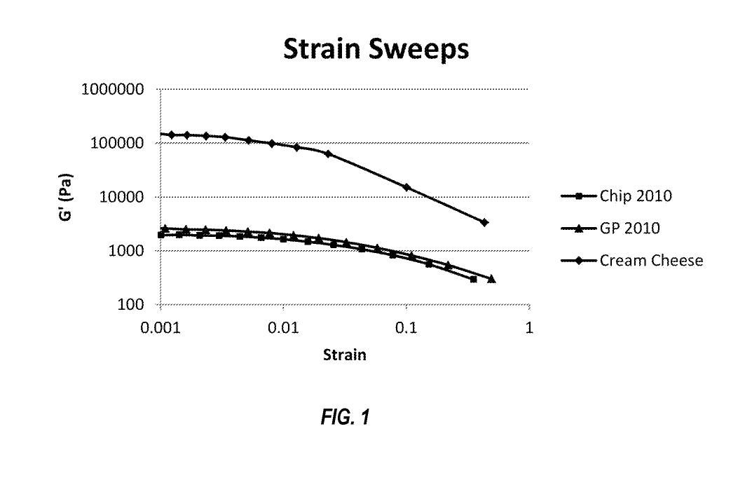

Thick, viscous food compositions that are suitable for sandwich spreads, dips, and the like may have a linear viscoelastic region, or LVR, a region of low strain in which rheological quantities such as G′. G″, and δ are constant (see FIGS. 1-3). In the LVR, the microstructural network stretches but remains intact (i.e. particles maintain their relative positions). Spreading such compositions over a surface involves much larger strains that disrupt and break up the network. However, such disruptions often do not occur uniformly, leaving smaller spatial units in which some of the original microstructural integrity is maintained. LVR quantities therefore often translate to observable macroscopic behavior, as these smaller, more intact units act in aggregate. (See for example the relationship between complex viscosity and mouthfeel thickness in Gunasekaran et al.)

G′ in the LVR can be thought of as a spring constant of the material at small strains, before the network starts to break down. A material with a larger G′ in the LVR is a stiffer material that takes more effort to deform. Thus, without being bound by theory, G′ in the LVR relates to the ease with which a material can be spread over a surface. For example, cream cheese has a higher resistance to being spread than the inventive compositions (see FIG. 1), and makes a thicker layer when the same force is applied. FIG. 1 shows that cream cheese has a substantially higher G′ in the LVR than do the inventive compositions.

G′ in the LVR of the inventive compositions is thus desired to be below about 100,000 Pa, or more preferably, below about 10,000 Pa, from about 500 to about 5000 Pa, or from about 1000 Pa to about 3200 Pa for ease of forming a layer of the desired thickness when spreading. Some embodiments may exhibit a value of G′ in the LVR from about 1500 Pa to about 5000 Pa, or about 1750 Pa to about 3200 Pa. The Chip 2010 and GP 2010 examples seen in FIG. 1 exhibit a G′ value from about 2000 Pa and about 2600 Pa, respectively.

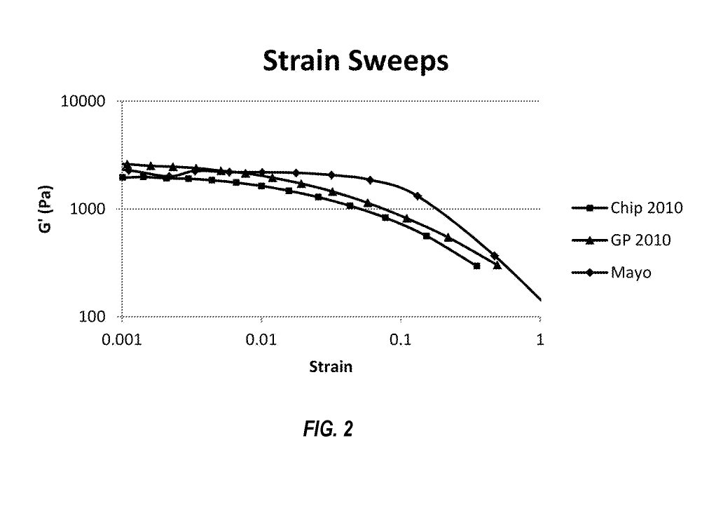

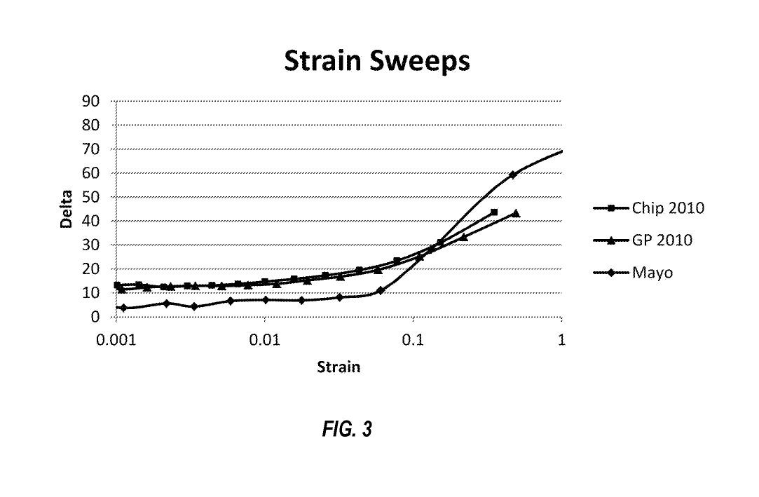

δ in the LVR represents the relative viscous to elastic response of the material at small strains. A material with a lower δ will behave more elastically, with a tendency to recoil, or return to a previous shape, rather than dissipate the energy and stay where put. Without being bound by theory, it is believed that δ in the LVR is related to the evenness of the spread material. For example, mayonnaise has a G′ in the LVR that is more similar to the inventive compositions (FIG. 2) than to cream cheese (FIG. 1). It was also observed that mayonnaise forms a layer of similar thickness with approximately equal ease. However, mayonnaise, has a significantly lower δ in the LVR than the inventive compositions at strain values lower than 0.1 (FIG. 3). This difference in δ exhibits itself in mayonnaise recoiling slightly at the edges after being spread, requiring additional passes in order to spread evenly to the edges.

δ in the LVR of the inventive compositions is thus desired to be higher than about 10 degrees, which exhibits itself in more even spreading as compared to mayonnaise. By way of example, the δ may be at least 9 degrees, at least 10 degrees, or from 9 degrees to 20 degrees.

Thus, both G′ in the LVR and δ in the LVR relate to ease of forming an even layer of the desired thickness. In addition, added solids are known to reduce elasticity of the background matrix (See H. A. Barnes, A Review of the Rheology of Filled Viscoelastic Systems, Rheology Reviews, 1-36 (2003). Without being bound by theory, it is believed that the presence of the additional solids that provide the hearty texture associated with the present inventive compositions may also result in a higher δ in the LVR, and thus better spreadability.

Finally, not all spreads have a well-defined LVR, although one may still apply similar interpretations and criteria for G′ and δ at low enough strains, for example 0.01 and below. The inventive spreads are therefore not limited to those that have a well-defined LVR.

As described, the inventive compositions exhibit a more hearty texture than that exhibited by mayonnaise. This results at least in part from the inclusion of the cream cheese and legume-based components within the inventive compositions. By way of example, and as illustrated by the Figures, the compositions may have an elastic modulus (G′) of less than 100,000 Pa, less than 10,000 Pa, from 500 Pa to 5000 Pa, or from 1000 Pa to 3200 Pa, and a δ of at least 9 at least 10 degrees, or from 9 degrees to 20 degrees.

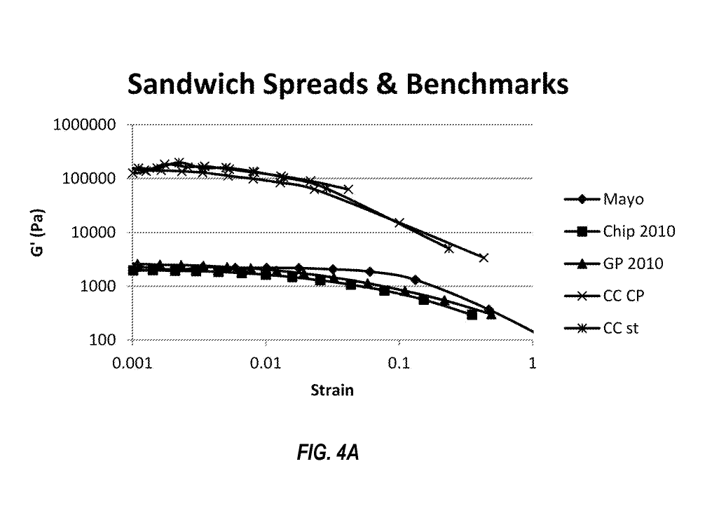

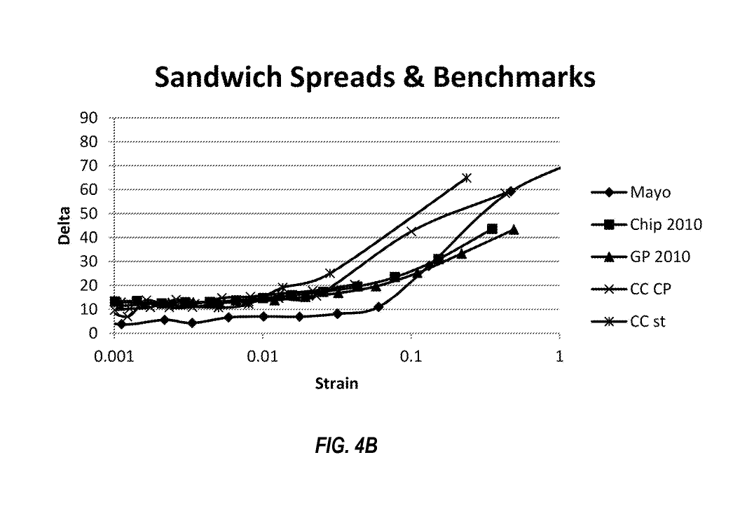

FIG. 4A shows strain versus elastic modulus plots for several exemplary inventive compositions as compared to mayonnaise (mayo), cream cheese (CC CP and CC st). FIG. 4B shows strain versus phase angle plots for these same comparative compositions.

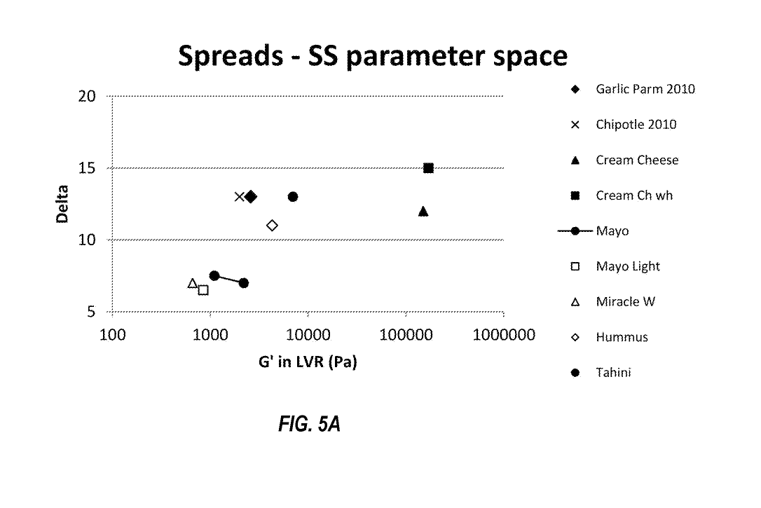

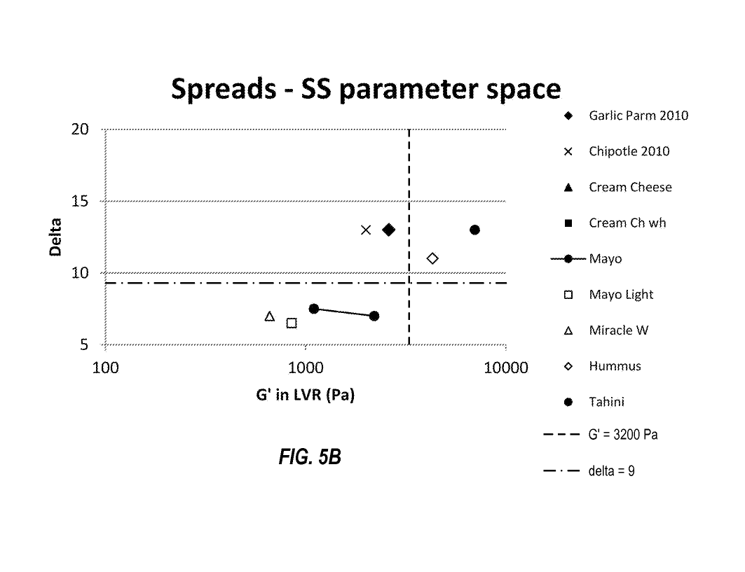

FIG. 5A shows elastic modulus in the LVR and phase angle data for several exemplary inventive compositions as compared to mayonnaise (mayo, mayo light), MIRACLE WHIP (Miracle W), hummus, tahini (a paste of ground sesame seeds), and cream cheese and whipped cream cheese. FIG. 51 shows a close up of a portion of the same data plotted in FIG. 5A,

### VIII. Exemplary Compositions

### Example 1

A sandwich spread and dip composition was prepared by mixing together with the following components in the manner described below:

| | | Weight Percent |
|---|---|---|
| | | Range |
| | | Anticipated to |
| | Actual | Provide |
| | Weight | Equivalent |
| Component | Percent | Results |
| Water | 54.5 | 50-55 |
| Polyphosphate | 0.3 | 0.1-6.5 |
| Mono and/or other glycerides (emulsifier) | 0.4 | 0.1-0.5 |
| Cream Cheese Powder | 5 | 2.5-8 |
| Cream Cheese Sauce | 5 | 2.5-8 |
| Other Dairy Components | 3.6 | 2-4 |
| Cellulose and Guar Gum(hydrocolloid) | 0.2 | 0.1-0.5 |
| Vegetable Oil | 9.0 | 5-10 |
| Shortening | 9.0 | 5-10 |
| Phosphoric Acid | 0.95 | 0.5-1 |
| Vinegar | 0.084 | 0.05-2 |
| Modified Food Starch | 1.0 | 0.5-2 |
| Flavorants and Seasonings | 7.93 | 6-9 |
| Dried Kidney Beans | 3.0 | 1-5 |

The water was heated to 170° F. and mixed with the polyphosphate in a thermomix. The emulsifier was added to the thermomix. The dairy components including cream cheese powder and cream cheese sauce, as well as other dairy components (e.g., cultured non-fat buttermilk, buttermilk, buttermilk flavor, and whey protein concentrate) were added to the thermomix. The hydrocolloid thickeners, the vegetable oil, shortening, and acids were added to the thermomix. The resulting mixture was homogenized and transferred back to the thermomix. The modified food starch was added to the thermomix. The flavorants and seasonings were added to the thermomix. The dried beans were added to the thermomix and cooked to 195° F. for 5 minutes. The resulting sandwich spread and dip composition was hot filled into glass jars, which were inverted and cooled.

The resulting composition exhibited a texture that was significantly more hearty than that provided by mayonnaise or similar compositions (e.g., MIRACLE WHIP). In addition, the composition exhibited no noticeable tendency to phase separate, e.g., through syneresis of the dairy components, protein precipitation, or retrograde of the bean component by which water separates from the solid portion of the bean component. These phase stability characteristics were found to continue for a period of at least several months, so that the composition was shelf-stable for a period of at least 6 months. For example, shelf-stability has been confirmed to be at least 12 months.

The composition exhibited characteristics similar to the test results of the inventive compositions shown in the Figures, with an elastic modulus that is less than 10.000 Pa, with a δ greater than 10 degrees.

### Example 2

A sandwich spread and dip composition was prepared by mixing together the following components in the manner described below:

| | | Weight Percent |
|---|---|---|
| | | Range |
| | | Anticipated to |
| | | Provide |
| | Weight | Equivalent |
| Component | Percent | Results |
| Spice Preblend | 4.5 | 4-12 |
| Dairy Preblend | 4.0 | 4 |
| Fat Mixture | 13.9 | 5-1.5 |
| Soft Potable Water | 47.2 | 45-55 |
| Sodium Polyphosphate | 0.3 | 0.1-0.3 |
| Cream Cheese Sauce | 15.0 | 5-15 |
| Cellulose and Guar Gum (hydrocolloids) | 0.2 | 0.1-1.0 |
| Soybean Oil | 4.5 | 5-15 |
| Acidification Mixture | 2.3 | 0.5-2 |
| Modified Food Starch | 2.0 | 0.5-2 |
| Flavorants and Seasoning | 5.0 | 1-5 |
| DriedKidney Beans | 1.5 | 1-5 |

The spice flavorant preblend was prepared by mixing together sugar, salt, monosodium glutamate, sorbic acid, garlic powder, onion powder, spices, sodium benzoate, and calcium disodium EDTA.

The dairy preblend was prepared by mixing together parmesan cheese, cheese flavorant, artificial parmesan flavorant, and whey protein concentrate.

The fat mixture was prepared by melting together shortening and mono and diglycerides.

An emulsion was prepared by mixing together a group A including water and sodium polyphosphate; a group B including the dairy preblend described above and cream cheese sauce; a group C including xanthan gum; and a group D including soybean oil and the fat mixture described above. The mixing was achieved in a Breddo mixer, while the mixture was heated to 170° F.

The emulsion was acidified by addition of a group E, including Dijon mustard, garlic flavor, lemon flavor, and lemon juice concentrate; and a group F, including phosphoric acid and vinegar to the emulsion prepared as described above. Groups E and F together made up the Acidification Mixture. The acidified emulsion was mixed and homogenized.

The composition was completed by addition to the acidified emulsion of a group G including modified food starch and the spice flavorant preblend; and group H including grated parmesan cheese, minced dehydrated garlic, and white kidney bean flakes. The composition was mixed in the Breddo mixer, cooked, and hot filled into glass jars, which were inverted and cooled.

The resulting composition exhibited a texture that was significantly heartier than that provided by mayonnaise or similar compositions (e.g., MIRACLE WHIP). In addition, the composition exhibited no noticeable tendency to phase separate, e.g., through syneresis of the dairy components, protein precipitation, or retrograde of the bean component by which water separates from the solid portion of the bean component. These phase stability characteristics were found to continue for a period of at least several months, so that the composition was shelf-stable for a period of at least 12 months.

The composition exhibited characteristics similar to the test results of the inventive compositions shown in the Figures, with an elastic modulus that is less than 10,000 Pa, with a δ greater than 10 degrees.

While the present invention has been described with reference to what are presently considered to be the preferred embodiments, it is to be understood that the invention is not limited to these embodiments. To the contrary, the invention is intended to cover various modifications and equivalent arrangements included within the spirit and scope of the appended claims.

1. A shelf-stable textured sandwich spread or dip composition comprising:
(a) a dairy component comprising cream cheese;
(b) an oil-water emulsion comprising oil and water; and
(c) a legume-based component comprising a paste, flake or granule, which with the dairy component provides texture to the sandwich spread or dip;
(d) wherein the dairy component, the oil-water emulsion, and the legume-based component are homogeneously present throughout the composition and exhibit phase stability such that proteins and other solid components of the composition do not retrograde or precipitate, and wherein the composition has an elastic modulus of less than 100,000 Pa and a phase angle of at least 9 degrees as measured on a Stresstech Rheometer with parallel plate geometry and 1 mm gap (or cone and plate geometry for non-particulate samples at 10° C., running strain sweep experiments at a frequency of 1 Hz, and
(e) wherein the legume-based component is not a finely ground powder.

2. The shelf-stable textured sandwich spread or dip composition of claim 1, wherein the composition has an elastic modulus of less than 10,000 Pa and a phase angle of at least 10 degrees as measured on a Stresstech Rheometer with parallel plate geometry and 1 mm gap (or cone and plate geometry for non-particulate samples), at 10° C., running strain sweep experiments at a frequency of 1 Hz.

3. The shelf-stable textured sandwich spread or dip composition of claim 1, wherein the composition has an elastic modulus from 500 Pa to 5000 Pa and a phase angle from 9 degrees to 20 degrees as measured on a Stresstech Rheometer with parallel late geometry and 1 mm gap (or cone and plate geometry for non-particulate samples), 10° C., running strain sweep experiments at a frequency of 1 Hz.

4. The shelf-stable textured sandwich spread or dip composition of claim 1, wherein the legume-based component is a bean-based component selected from the group consisting of kidney beans, navy beans, garbanzo beans, pinto beans, fava beans, soybeans, and combinations thereof.

5. (canceled)

6. The shelf-stable textured sandwich spread or dip composition of claim 1,
wherein the legume-based component comprises from about 0.5% to about 5% by weight of the composition.

7. The shelf-stable textured sandwich spread or dip composition of claim 1,
wherein the legume-based component comprises from about 1% to about 4% by weight of the composition.

8. The shelf-stable textured sandwich spread or dip composition of claim 1,
wherein the cream cheese comprises from about 3% to about 30% by weight of the composition.

9. The shelf-stable textured sandwich spread or dip composition of claim 1,
wherein the cream cheese comprises from about 10% to about 20% by weight of the composition.

10. The shelf-stable textured sandwich spread or dip composition of claim 1, wherein the dairy component comprising cream cheese further comprises one or more acids so that the dairy component is acidified, and wherein the acidified dairy component does not undergo syneresis or protein precipitation.

11. A shelf-stable textured sandwich spread or dip composition comprising:
(a) a dairy component comprising cream cheese, the cream cheese comprising from about 3% to about 30% by weight of the composition;
(b) an oil-water emulsion comprising oil and water; and
(c) a legume-based component, which with the dairy component provides texture to the sandwich spread or dip, the legume-based component comprising from about 0.5% to about 5% by weight of the composition;
(d) wherein the dairy component, the oil-water emulsion, and the legume-based component are homogeneously present throughout the composition and exhibit phase stability such that proteins and other solid components of the composition do not retrograde or precipitate, even when hot filled into a container, and
(e) wherein the legume-based component is not a finely ground powder.

12. The shelf-stable textured sandwich spread or dip composition of claim 11, wherein the composition has an elastic modulus of less than 10,000 Pa and a phase angle of at least 9 degrees as measured on a Stresstech Rheometer with parallel plate geometry and 1 mm gap (or cone and plate geometry for non-particulate samples), at 10° C., running strain sweep experiments at a frequency of 1 Hz.

13. The shelf-stable textured sandwich spread or dip composition of claim 11, wherein the composition has an elastic modulus from 500 Pa to 5000 Pa and a phase angle from 9 degrees to 20 degrees as measured on a Stresstech Rheometer with parallel plate geometry and 1 mm gap or cone and plate geometry for non-particulate samples), at 10° C., running strain sweep experiments at a frequency of 1 Hz.

14. The shelf-stable textured sandwich spread or dip composition of claim 11, wherein the legume-based component is a bean-based component selected from the group consisting of kidney beans, navy beans, garbanzo beans, pinto beans, fava beans, soybeans, and combinations thereof.

15. (canceled)

16. The shelf-stable textured sandwich spread or dip composition of claim 11, wherein the dairy component comprising cream cheese further comprises one or more acids so that the dairy component is acidified, and wherein the acidified dairy component does not undergo syneresis or protein precipitation, even when hot filled into a container.

17. A shelf-stable textured sandwich spread or dip composition comprising:
(a) a dairy component comprising cream cheese, the cream cheese comprising from about 3% to about 30% by weight of the composition;
(b) an oil-water emulsion comprising oil and water; and
(c) a bean-based component, which with the dairy component provides texture to the sandwich spread or dip, the bean-based component comprising from about 0.5% to about 5% by weight of the composition, the bean-based component being selected from the group consisting of kidney beans, navy beans, garbanzo beans, pinto beans, fava beans, soybeans, and combinations thereof;
(d) wherein the dairy component, the oil-water emulsion, and the bean-based component are homogeneously present throughout the composition and exhibit phase stability such that proteins and other solid components of the composition do not retrograde or precipitate, even when hot filled into a container,
(e) wherein the bean-based component is not a finely ground powder.

18. The shelf-stable textured sandwich spread or dip composition of claim 17, wherein the composition has an elastic modulus from 500 Pa to 5000 Pa and a phase angle from 9 degrees to 20 degrees as measured on a Stesstech Rheometer with parallel plate geometry and 1 mm gap (or cone and plate geometry for non-particulate samples), at 10° C., running strain sweep experiments at a frequency of 1 Hz.

19. (canceled)

20. The shelf-stable textured sandwich spread or dip composition of claim 17, wherein the dairy component comprising cream cheese further comprises one or more acids so that the dairy component is acidified, and wherein the acidified dairy component does not undergo syneresis or protein precipitation, even when hot filled into a container.
